(19) United States
(12) Patent Application Publication
(10) Pub. No.: US 2024/0269761 A1
(43) Pub. Date: Aug. 15, 2024

(54) WELDING DEVICE AND WELDING METHOD

(71) Applicant: Fronius International GmbH, Pettenbach (AT)

(72) Inventors: Dominik SÖLLINGER, Wels-Thalheim (AT); Michael MUSS, Wels-Thalheim (AT)

(73) Assignee: Fronius International GmbH, Pettenbach (AT)

(21) Appl. No.: 18/559,865

(22) PCT Filed: May 9, 2022
(86) PCT No.: PCT/EP2022/062472

§ 371 Date: Nov. 9, 2023

(30) Foreign Application Priority Data
May 10, 2021 (EP) 21173138.5

(51) Int. Cl. B23K 9/095

(52) U.S. Cl. CPC B23K 9/0956

(57) ABSTRACT

A welding device allows uninterrupted welding with maximum welding quality even in the case of welding processes performed simultaneously in close proximity by several welding devices. In a normal operating mode, the control unit of the welding device ignores a first welding voltage signal of a first voltage-measuring device and uses a second welding voltage signal, detected closer to the are, of a second voltage-measuring device to determine the control parameters. The control unit detects an error state in the second welding voltage signal on the basis of the second welding voltage signal and, upon detecting the error state, switches to an emergency operating mode without interrupting the welding process. In the emergency operating mode, the control unit ignores the second welding voltage signal of the second voltage-measuring device and uses the first welding voltage signal of the first voltage-measuring device to determine the control parameters.

The invention relates to a welding device for carrying out a welding process on a workpiece with an electrode, wherein a welding current source is provided in the welding device, and has a first connection socket for electrically connecting a welding torch by means of a welding lead, and a second connection socket for electrically connecting a workpiece by means of a ground cable, wherein a first voltage-measuring device is provided in the welding device for detecting a first electrical welding voltage signal between the connection sockets, wherein a voltage measuring socket is provided in the welding device for connecting a measuring line, or two voltage measuring sockets are provided, each for connecting one measuring line, wherein a second voltage-measuring device is provided in the welding device for detecting a second electrical welding voltage signal between the one voltage measuring socket and one of the connection sockets, or between the two voltage measuring sockets, wherein a control unit is provided in the welding device, and is designed to use at least one of the welding voltage signals for determining control parameters for controlling the welding process, and to control the welding current source with the determined control parameters.

The invention further relates to a method for carrying out a welding process with an electrode on a workpiece, wherein the electrode is connected to a welding current source via a welding lead, and the workpiece is connected to the welding current source via a ground cable, wherein, after the ignition of an arc between the electrode and the workpiece, a welding current circuit is completed, wherein a first electrical welding voltage signal and a second electrical welding voltage signal are detected in the welding current circuit, wherein the second electrical welding voltage signal is detected closer to the arc than the first electrical welding voltage signal, wherein the detected welding voltage signals are transmitted to a control unit, and wherein the control unit uses at least one of the welding voltage signals to determine control parameters for controlling or regulating the welding process, and wherein the control unit controls the welding current source with the determined control parameters.

A conventional MIG/MAG or TIG welding device requires a signal—typically embodied as an actual value—of a welding voltage of the welding current circuit in order to regulate the welding process. As is known, the welding current circuit is formed by a welding torch with a (consumable or non-consumable) electrode arranged therein being connected to an electrical terminal of a welding current source (usually the positive terminal), and the other terminal (usually the negative terminal) being connected to a workpiece. As a rule, a first connection socket is provided for this purpose, to which the welding torch can be connected by means of a welding lead, and a second connection socket is provided, to which the workpiece can be connected by means of a ground cable. After an arc has been ignited between the electrode and the workpiece in a known manner, the welding current circuit is completed, and a desired welding process (e.g., a pulse arc process, short arc process, etc.) can be carried out with certain welding parameters (welding current, welding voltage, etc.).

The welding voltage in the welding current circuit is generally measured with a voltage measuring unit, which is usually arranged in the welding device. However, due to the design, this means that only the welding voltage between the connection sockets of the power source can be measured. In order to be able to regulate the welding process as precisely as possible, however, the arc voltage directly at the arc is of interest. Importantly, this differs from the measured socket voltage at the connection sockets due to voltage drops in the welding lead and in the ground cable. A regulation of the welding process on the basis of the measured socket voltage therefore leads to an imprecise regulation, and consequently to unsatisfactory welding quality.

It has therefore become known in the prior art to determine the voltage drops by means of a model, and to correct the measured socket voltage accordingly. This can be done, for example, by means of a so-called RL comparison, in which the welding lead is modeled by resistors and inductors, as disclosed in EP 1 183 125 B1. This method provides satisfactory results when one welding process is carried out using a welding device. However, if several welding processes are carried out in parallel, e.g., in the same welding cell, it can happen that the ground cables and/or the welding leads of the different welding devices are laid directly in spatial proximity to one another—for example, parallel to one another in sections thereof. As a result, the voltage-carrying lines can mutually influence each other electromagnetically—in particular causing a voltage induction which cannot be taken into account or can only be taken into account insufficiently by the model.

A further possibility is therefore known for determining the welding voltage as close as possible to the arc. In this case, the voltage measurement takes place directly in the vicinity of the arc, by virtue of the fact that the voltage measurement tap takes place, for example, on the electrode (TIG) or on the contact tube in the welding torch (MIG/MAG) and on the workpiece, or as close as possible to the workpiece. The voltage is generally tapped in this case by means of separate sensor lines, and the measuring circuit for the actual voltage measurement is located, for example, in the welding device. Although this type of measurement also provides reliable results for several welding processes carried out in parallel, it has the disadvantage, however, in comparison with the socket voltage measurement with RL-compensation, that the sensor lines always have to be connected to the measuring points. If one of the two sensor lines then becomes detached during the welding process, or an electrical interruption of a sensor line occurs in some other way, no voltage is measured anymore, and the arc control no longer works. The welding process then generally has to be interrupted, because sufficient welding quality can no longer be achieved.

JP 201451355 A discloses a method for detecting abnormalities of the lines in the hose pack or in the external voltage measuring lines. The method determines the measuring line in which an abnormality occurs. The voltage measurements of the two measuring lines are compared, and, if an abnormality is determined in the form of a certain deviation between the two voltage measurement values, the current source is interrupted and the welding process halted. However, the problem that the welding process has to be interrupted cannot be eliminated.

It is therefore an object of the invention to provide a welding device and a welding method which enable uninterrupted welding with as high a welding quality as possible, even in the case of several welding processes which are carried out simultaneously in spatial proximity with several welding devices.

The object is achieved according to the invention with a welding device mentioned at the outset in that the control unit is designed, in a normal operating mode, to ignore the first welding voltage signal of the first voltage-measuring device and to use the second welding voltage signal of the second voltage-measuring device for determining the control parameters, in that the control unit is further designed to detect an error state in the second welding voltage signal on the basis of the second welding voltage signal and to switch to an emergency operating mode upon detecting the error state, without interrupting the welding process, and in that the control unit is designed to ignore the second welding voltage signal of the second voltage-measuring device in an emergency operating mode and to use the first welding voltage signal of the first voltage-measuring device to determine the control parameters. A second welding voltage signal, which is measured closer to the arc than the first welding voltage signal, can accordingly be used to regulate the welding process. As a result, the measured voltage value of the second welding voltage signal better corresponds to the actual arc voltage of interest at the arc, because, on the one hand, voltage drops in the welding lead and/or the ground cable are not measured, and, on the other, any induced voltages of other welding devices are also not measured. As soon as a fault of a second welding voltage signal is detected, e.g., because a measuring line has been detached or broken, a switchover to the first welding voltage signal takes place automatically and without interruption of the welding process. The welding process therefore does not have to be interrupted in the event of a fault, and can be completed—possibly with a slightly reduced welding quality. After the welding process has ended, the fault can be addressed, and the qualitatively better second welding voltage signal can again be used for controlling or regulating the welding process.

According to an advantageous embodiment, it is provided that a welding torch be electrically connected to the first connection socket by means of a welding lead, and a ground cable connected or connectable to the workpiece be electrically connected to the second connection socket, and that a first measuring line be connected to the voltage measuring socket, which first measuring line is electrically connected to a first voltage measuring point located between the first connection socket and the electrode of the welding torch in the welding lead, wherein the second voltage-measuring device is designed to detect the second electrical welding voltage signal between the one voltage measuring socket and the second connection socket. Alternatively, it is provided that a second measuring line be connected to the one voltage measuring socket, which second measuring line is electrically connected to a second voltage measuring point in the ground cable or can be electrically connected to the workpiece, wherein the second voltage-measuring device is designed to detect the second electrical welding voltage signal between the one voltage measuring socket and the first connection socket. As a result, the second welding voltage signal can also be measured closer to the arc than the first welding voltage signal, even with only one measuring line.

According to a particularly advantageous embodiment, it is provided that the welding torch be connected to the first connection socket by means of a welding lead, and a ground cable connected or connectable to the workpiece be connected to the second connection socket, that a first measuring line be connected to one of the two voltage measuring sockets, which first measuring line is electrically connected to a first voltage measuring point in the welding lead located between the first connection socket and the electrode of the welding torch, and a second measuring line be connected to the other voltage measuring socket, which second measuring line is electrically connected to a second voltage measuring point in the ground cable, or can be electrically connected to the workpiece. As a result, the second welding voltage signal can advantageously be measured even closer to the arc than the first welding voltage signal.

Preferably, the first measuring line and the second measuring line are twisted at least in sections thereof. As a result, it is possible to prevent, for example, an electrical voltage from other welding devices whose lines are laid in spatial proximity being induced in the measuring lines, which would falsify the measured voltage under certain circumstances.

In the welding device, a feed unit for supplying a welding wire to the welding torch can advantageously be provided, wherein the second voltage-measuring device and the one voltage measuring socket or the two voltage measuring sockets are provided on the feed unit, and wherein the second voltage-measuring device is connected to the control unit via a communications connection for transmitting the second electrical welding voltage signal. A separate feed unit spatially separated from the welding current source can accordingly be used. The second voltage-measuring device can be integrated, for example, into the feed unit, and the voltage measuring sockets can be arranged on the feed unit. The communications connection can, for example, be designed as a data bus in order to transmit the second welding voltage signal to the control unit of the welding device with as little time delay as possible, wherein the welding device is preferably arranged in the region of the welding current source and thus also spatially separate from the feed unit.

It can also be advantageous if an additional measurement voltage source is provided in the welding device, which source is connected to the two voltage measuring sockets or to which a voltage measuring socket and one of the connection sockets are connected, wherein the control unit is designed to detect the error state in the second welding voltage signal on the basis of an electrical measurement voltage generated by the measurement voltage source. It is particularly advantageous if the measurement voltage source has an opposite electrical polarity to that of the welding current source. The detection of the error state is simplified in this way, and in particular accelerated, because the reversal of the polarity can be detected more easily.

It is advantageous if the measurement voltage source is connected to at least one voltage measuring socket with a high-impedance connection, and/or that the measurement voltage source is connected to at least one voltage measuring socket via at least one known ohmic resistor. Due to the high-impedance connection, the measurement voltage in normal operating mode for detecting the second welding voltage signal in the welding current circuit is negligible, so that no falsification of the second welding voltage signal results. If the ohmic resistance of the measurement voltage source is alternatively or additionally known, the voltage drop at the resistors can be calculated and taken into account during the detection of the second welding voltage signal, and the second welding voltage signal can optionally be corrected.

A welding current circuit model can also be stored in the control unit, and the control unit can be designed to recognize the error state in the second welding voltage signal on the basis of the welding current circuit model. The welding current circuit model preferably contains at least one model of the welding lead, wherein the model of the welding lead preferably contains at least one ohmic resistor and at least one inductor. The model parameters of the welding current circuit model can preferably be adapted to the welding current circuit of an actually-constructed welding device. By means of the model, a model value to be expected for the second welding voltage signal can thereby be calculated—preferably continuously—and compared with the second welding voltage signal actually detected. A deviation can be detected as an error state.

It can be advantageous if a welding robot is provided in the welding device, wherein the welding torch is arranged on the welding robot and is movable by the welding robot, and wherein the first voltage measuring point is provided on the welding robot—preferably in the region of the welding torch. As a result, the welding voltage can also be detected as close as possible to the arc in an automated welding method, and the switching according to the invention between normal operating mode and emergency operating mode can be carried out.

The object is also achieved by a method according to claim 11. Advantageous embodiments of the method are specified in dependent claims 12 through 15.

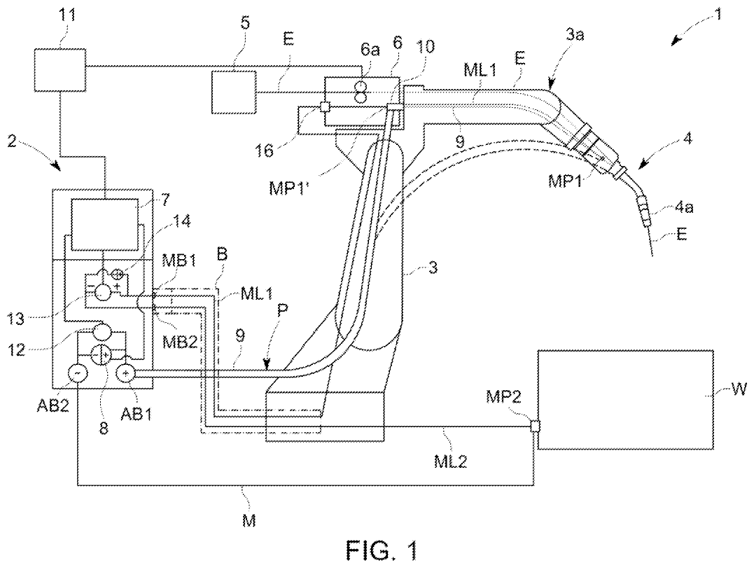

The present invention is described in greater detail below with reference to FIGS. 1 through 3, which show schematic and non-limiting advantageous embodiments of the invention by way of example. In the figures:

FIG. 1 is a welding device for carrying out a welding process,

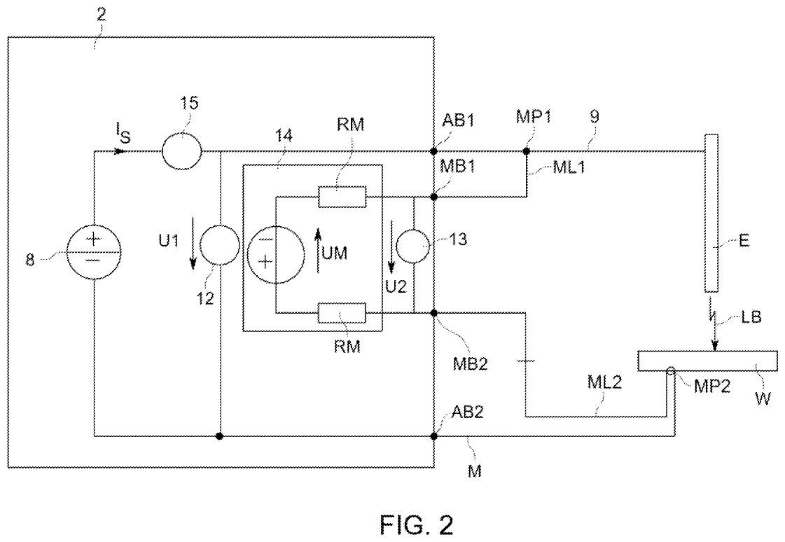

FIG. 2 is a measuring circuit for detecting an error state, and

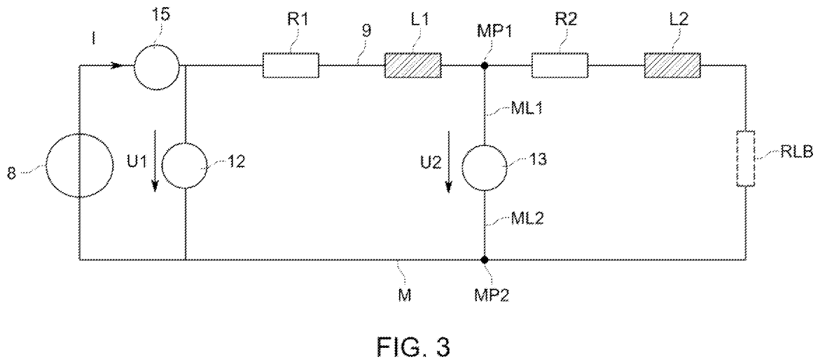

FIG. 3 is a welding current circuit model for detecting an error state.

FIG. 1 schematically shows a welding device 1 for carrying out a welding method according to the invention. The welding device 1 shown is designed to carry out a welding method with a consumable electrode, i.e., the known MIG/MAG method, or, generally, metal-protective gas method (MSG). Of course, this is to be understood only by way of example, and the invention could also be used in other welding methods—for example, in a welding method with non-consumable electrode (TIG). The welding device 1 shown has a welding tool 2 and a welding robot 3 on which a welding torch 4 is arranged. The welding torch 4 can be moved by the welding robot 3 in the available degrees of freedom in order to generate a weld seam (not shown) with a certain geometry on a workpiece W. However, the welding robot 3 is only optional, and the welding torch 4 could of course also be manually guided by a user.

As is known, a consumable electrode E in the form of a welding wire is provided on the welding torch 4. The welding wire can be supplied to the welding torch 4 by means of a feed unit 6, which is stored, for example, in a wire store 5. The feed unit 6 can have a drive unit 6a in order to supply the welding wire to the welding torch 4 or the (not shown) weld pool at the workpiece W at a desired feed rate. The drive unit 6a can be controlled by a suitable control unit in order to control or regulate the feed rate as a welding parameter according to a welding process carried out. In the example shown, the feed unit 6 is part of the welding robot 3. As such, for example, a robot control unit 11 which controls the drive unit 6a in a suitable manner can be used as a control unit for controlling the feed rate.

For controlling the welding method, the robot control unit 11 can communicate with a control unit 7 of the welding device 1—preferably arranged in the welding tool 2—in order to synchronize the speed of the advance of the robot with other welding parameters (welding current I, welding voltage U, etc.) of the welding process carried out. Both the welding process carried out and the movement of the robot 3 can then be controlled and coordinated with one another via the robot control unit 11. Of course, this is in turn only to be understood by way of example, and the feed unit 6 could also be a part of the welding tool 2—for example, integrated into the welding tool 2. This can be the case if, for example, no welding robot 3 is used, but, rather, the welding torch 4 is manually guided by a user.

Of course, several feed units 6 could also be provided, e.g., an additional feed unit (not shown) on the welding torch 4, in order to be able to control or regulate the feed rate dynamically. This can be advantageous in particular for carrying out the known CMT welding process in order to change the wire feed as quickly as possible between positive wire feed in the direction towards the workpiece W and negative wire feed in the direction of the workpiece W. Of course, the control unit 7 and/or the robot control unit 11 could in turn also be actuated by a higher-level control unit (not shown)—for example, in order to centrally control the welding methods and welding processes from several welding devices 1 and to synchronize them with one another.

In the welding device 1, e.g., in the welding tool 2, a welding current source 8 having a first connection socket AB1 and a second connection socket AB2 is provided in a known manner. The first connection socket AB1 and a second connection socket AB2 are electrically connected to the welding current source 8. The welding torch 4 can be connected to the first connection socket AB1 by means of a welding lead 9. The second connection socket AB2 can be connected to the workpiece W via a ground cable M. In the context of the invention, the connection sockets AB1. AB2 are to be understood as meaning both a detachable connection and a fixed, i.e., non-detachable, connection. However, detachable and preferably standardized couplings are generally used as connection sockets AB1, AB2. The first connection socket AB1 is usually designed as a positive terminal and the second connection socket AB2 as a negative terminal, as shown in FIG. 1. In principle, however, a polarity reversal of the connection sockets AB1, AB2 by the welding current source 8 would also be possible. Via the welding lead 9, the welding current source 2 supplies the welding torch 4 with the required welding current I (FIG. 2) in a known manner. For this purpose, for example, a contact sleeve 4a can be provided on the welding torch 4, which contact sleeve is connected to the welding lead 9, and via which the welding wire is electrically contacted.

As is known, the welding lead 9 can also be guided in a hose package P, in which further lines can also be provided in addition to the welding lead 9, which lines are necessary or advantageous for the welding process. In most cases, an (active or inert) protective gas is also used to carry out a welding process in order to shield the weld pool from the surroundings and to prevent oxidation. The protective gas can be supplied to the welding torch 4 by a protective gas container (not shown) via a suitable protective gas line, which can also be guided in the hose package P. Of course, a separate supply would also be possible. A pressure regulator, e.g., in the form of a bottle fitting arranged on the protective gas container, can also be provided, which pressure regulator can be controlled, for example, by the control unit 7 in order to control the flow of the protective gas. Furthermore, a cooling medium can optionally also be supplied to the welding torch 4 via the hose package P. In addition, control lines can also be provided in the hose package P, e.g., in order to control the above-described feed unit, which can optionally be arranged on the welding torch 4.

In the example shown, the hose package P connects the first connection socket AB1 of the welding tool 2 to a robot connection socket 10 of the welding robot 3. The welding lead 9 and the possible further lines within the robot arm 3a are guided between the robot connection socket 10 of the welding robot 3 and the welding torch 4. Of course, the hose package P could also be connected directly to the welding torch 4, as indicated in FIG. 1 using the dashed hose package P′. In a manual welding device 1, in which the welding torch 4 is guided by hand (instead of by a welding robot 3), the welding torch 4 can, for example, be connected directly via the hose package P to the welding tool 2 in which the welding current source 8 is provided. This is generally the case in TIG welding devices or in MIG/MAG welding devices in which the feed unit 6 is integrated into the welding tool 2.

In most manual MIG/MAG welding devices, however, the welding torch 4 is connected to a separate feed unit 6, e.g., via a first hose package, and the feed unit 6 is in turn connected to the welding tool 2 via a second hose package, for example. The system structure is thus similar to that of the welding device shown in FIG. 1 with a welding robot. In the example shown, the feed unit 6 is arranged on the welding robot 3. In the example shown, the consumable electrode E (the welding wire) is therefore not supplied to the welding torch 4 via the hose package P, but separately. The welding wire can, for example, be guided together with the welding lead and, optionally, further lines on or in the robot arm 3a. The welding wire can be electrically contacted by the welding lead 9 at the contact socket 4a.

In order to carry out a welding process (e.g., pulse welding process, CMT welding process, spray arc welding process, etc.), a first electrical potential (usually the negative terminal) is applied to the workpiece W by means of the ground cable M, and a second electrical potential (usually the positive terminal) is applied to the welding wire as an electrode E via the welding lead 9. After ignition of an arc LB (FIG. 2) between the free end of the welding wire (or the non-consumable electrode in the TIG welding method) and the workpiece W, a welding current circuit is completed, and a welding current I flows. The arc LB causes the welding wire and a part of the workpiece W to melt, so that a material bond is produced between the welding wire and the workpiece W.

During the welding process, the control unit 7 controls the welding current source 8 in order to set certain electrical welding parameters, such as the welding voltage U, the welding current I, a frequency f, etc. In addition, the control unit 7 can control further units in order, for example, to set further non-electrical welding parameters—for example, the feed unit(s) 6 and the pressure regulator of the protective gas container for controlling the feed rate of the welding wire and the protective gas quantity. The welding parameters to be set are substantially dependent upon the welding process to be carried out, and can generally be regarded as known. Depending upon the welding process carried out, the welding parameters can naturally vary qualitatively and quantitatively.

A user interface (not shown) which communicates with the control unit 7, can also be provided in the welding device 1—for example, on the welding tool 2. A user can adjust certain settings via the user interface. For example, a certain welding process can be selected, and certain welding parameters can be selected and/or set. For example, predefined welding programs with certain preset welding parameters can also be stored in the control unit 7, and can be selected by the user via the user interface. Of course, a higher-level robot control unit 11 could also be provided in the illustrated welding device 1 with a welding robot 3, and could communicate with the control unit 7 of the welding device 7 in a suitable manner. In this case, the welding process and the setting of welding parameters and so on could also be controlled by a user via the robot control unit 11 or a user interface connected thereto.

In the welding device 1—here, in the welding tool 2—a first voltage-measuring device 12 is also provided in order to measure a first electrical welding voltage signal U1 between the connection sockets AB1, AB2. Furthermore, also provided in the welding device 1 in the example shown are two voltage measuring sockets MB1, MB2 for connecting a measuring line ML1, ML2, and a second voltage-measuring device 13 for measuring a second electrical welding voltage signal U2 between the voltage measuring sockets MB1, MB2. The first and/or second voltage-measuring device 12, 13 can be designed as a separate unit, as shown in FIG. 1, but could also be integrated in a suitable manner into the control unit 7.

The control unit 7 and/or the voltage-measuring devices 12, 13 can be designed in the form of suitable hardware and/or software. In the example shown, the second voltage-measuring device 13 is integrated, for example, into the welding tool 2, and the two voltage measuring sockets MB1, MB2 are also provided on the welding tool 2—for example, on a housing of the welding tool 2. The measuring lines ML1, ML2 can thus be directly connected to the welding tool 2. However, it would basically be sufficient if only one voltage measuring socket MB1 or MB2 were provided in the welding device 1. In this case, the second voltage-measuring device 13 would be designed to detect the second welding voltage signal U2 between the available voltage measuring socket MB1, MB2 and one of the connection sockets AB1, AB2.

As shown in FIG. 1, an external feed unit 6 for supplying the welding wire to the welding torch 4 can be provided in the welding device 1, which feed unit is arranged to be spatially separated from the welding current source 8. This can be the case both in the illustrated use of a welding robot 3 and for manual welding. The second voltage-measuring device 13 and the two voltage measuring sockets MB1, MB2 (or the one voltage measuring socket MB1 or MB2) could, for example, also be provided on the feed unit 6, and the voltage-measuring device 13 could be connected to the control unit 7 via a suitable communications connection in order to transmit the second electrical welding voltage signal U2. A known data bus, for example, can be used as a communications connection in order to transmit the second welding voltage signal U2 with the lowest possible time delay. Of course, however, the feed unit 6 could also be structurally combined with the welding current source 8 in a known manner and, for example, be integrated together with the welding current source 8 and optionally further components (control unit 7, voltage-measuring devices 12, 13, etc.) into the housing of the welding tool 2.

The control unit 7 is designed to use at least one of the welding voltage signals U1, U2 for determining control parameters for controlling the welding process and to control the welding current source 8 as a function of the determined control parameters. For example, a suitable controller can be provided in the control unit 7 for this purpose, which controller uses at least one of the welding voltage signals U1, U2 as an actual value of the control. A welding voltage U of the welding current circuit specified according to a desired welding process can be used as a target value, for example. According to a specific control ruleset, the controller calculates an actuating variable as a control parameter therefrom. The control unit 7 can then control the welding current source 8 with the determined actuating variable—for example, in order to set the target value of the welding voltage U.

According to the invention, it is then provided that the control unit 7, in a normal operating mode, ignore the first welding voltage signal U1 of the first voltage-measuring device 12, and the second welding voltage signal U2 of the second voltage-measuring device 13 be used to determine the control parameters. The control unit 7 is also provided to detect an error state in the second welding voltage signal U2 on the basis of the second welding voltage signal U2, as will be explained in more detail below. If the control unit 7 detects the error state in the second welding voltage signal U2, the control unit 7 automatically changes into an emergency operating mode within the shortest possible time, without the welding process being interrupted. In the emergency operating mode, the control unit 7 then ignores the second welding voltage signal U2 of the second voltage-measuring device 12, and instead uses the first welding voltage signal U1 of the first voltage-measuring device 12 to determine the control parameters.

For carrying out the welding process, the second welding voltage signal U2 is thus used as the standard, and the emergency operating mode is automatically activated only in the event of a fault, in which case the first welding voltage signal U1 is used. No user intervention is required for detecting the error state and switching from the normal operating mode to the emergency operating mode. In the emergency operating mode, the RL comparison mentioned earlier can naturally also be carried out by means of a suitable welding circuit model, which can be implemented, for example, in the control unit 7. An error state in the second welding voltage signal U2 of the second voltage-measuring device 13 is present, for example, when a measuring line ML1, ML2 detaches from the corresponding voltage measuring socket MB1, MB2 or when a measuring line ML1, ML2 breaks or is partially damaged. In the context of the invention, the error state of the second welding voltage signal U2 is generally to be understood as a state in which no welding voltage signal U2 is detected, at least temporarily, or the detected welding voltage signal U2 deviates at least temporarily from a value expected due to the welding process being performed. “Temporarily” means, for example, a specific prespecified or adjustable time period.

During operation of the welding device 1, a first measuring line ML1 is advantageously connected to the first voltage measuring sockets MB1, and a second measuring line ML2 is connected to the other voltage measuring socket MB2, as shown in FIG. 1. The connection sockets AB1, AB2 and the voltage measuring sockets MB1, MB2 can, for example, be provided on a housing of the welding tool 2, as shown in FIG. 1. If an external feed unit 6 is provided, the voltage measuring sockets MB1, MB2 (or the one voltage measuring socket MB1 or MB2) can, as mentioned, also be provided directly on the feed unit 6. If the second voltage-measuring device 13 is provided in the welding tool 2, the measuring line(s) ML1, ML2 can then be looped through the feed unit 6. If the second voltage-measuring device 13 is provided in the feed unit 6, the second welding voltage signal U2 can then directly be transmitted via the communications connection to the control unit 7, which is preferably also arranged in the welding tool 2. Analogously to the connection sockets AB1, AB2, in the context of the invention, both a detachable coupling or plug connection and a fixed, i.e., non-detachable, connection are to be understood as the voltage measuring sockets MB1, MB2.

The first measuring line ML1 is preferably electrically connected to a first voltage measuring point MP1 located between the first connection socket AB1 and the electrode E of the welding torch 4 in the welding lead 9. The second measuring line ML2 is preferably electrically connected to a second voltage measuring point MP2 in the ground cable M or directly to the workpiece W. As a result, the second welding voltage signal U2 can be measured closer to the arc LB than the first welding voltage signal U1, which is measured between the two connection sockets AB1, AB2. In principle, the closer the second welding voltage signal U2 can be tapped to the arc LB, the more precisely the measured voltage corresponds to desired voltage of the arc, because the voltage drop in the welding lead 9 is lower. The connection of the measuring lines ML1, ML1 to the voltage measuring points MP1, MP2 can in turn be fixed or detachable.

As mentioned above, only one voltage measuring socket MB1 or MB2 can also be provided in the welding device 1—for example, only the first voltage measuring socket MB1 or the second voltage measuring socket MB2. As shown, the first voltage measuring socket MB1 could be connected to the first voltage measuring point MP1 of the welding lead 9 by means of a first measuring line ML1. The second voltage-measuring device 13 measures the second welding voltage signal U2 in this case between the first voltage measuring point MP1 and the second connection socket AB2, which is connected to the ground cable M with the workpiece W. However, only the second voltage measuring socket MB2 could also be provided, and it could be electrically connected, as shown, via a second measuring line ML2 to the second voltage measuring point MP2 in the ground cable M or directly to the workpiece W.

The second voltage-measuring device 13 measures the second welding voltage signal U2 in this case between the second voltage measuring point MP2 and the first connection socket AB1, which is connected to the welding torch 4 via the welding lead 9. As a result, the second welding voltage signal U2 can also be measured closer to the arc with only one voltage measuring socket MB1, MB2 and one measuring line ML1, ML2. Depending upon the embodiment, however, the voltage drop in the welding lead 9 or the ground cable remains disregarded. It is therefore advantageous if two voltage measuring sockets MB1, MB2 are provided in the welding device 1, as shown in FIG. 1, which are each connected to the welding lead 9 and/or the ground cable M or the workpiece W with a measuring line ML1, ML2.

In the example shown, the first voltage measuring point MP1 is located, for example, on the robot arm 3a in the vicinity of the welding torch 4 and is thus not accessible, or is quite difficult to access from the outside. It can therefore be advantageous if a suitable measuring line connection socket 16 is provided on the welding robot 3, to which the first measuring line ML1 can be connected in a simple manner. The section of the first measuring line ML1 extending between the measuring line connection socket 16 and the first voltage measuring point MP1 in this case is a part of the welding robot 3 and can be arranged in or on the robot arm 3a. The second voltage measuring point MP2 lies directly on the workpiece W in this case, and can be designed, for example, as a suitable terminal.

However, the first voltage measuring point could of course also be provided at a location which is more easily accessible from the outside, e.g., on the robot connection socket 10, as indicated by the voltage measuring point MP1′ in FIG. 1. However, in this case, the second welding voltage signal U2 would be tapped further from the arc LB in comparison to the first voltage measuring point MP1 on the robot arm 3a. Due to the greater line length of the welding lead 9, this also results in a greater voltage drop and consequently a greater deviation between the measured welding voltage and the actual arc voltage. Advantageously, the first voltage measuring point MP1 therefore lies as close as possible to the arc LB. If a suitable ground cable M is provided, the second voltage measuring point MP2 can also be provided directly at the ground cable M. Here, too, it is advantageous for the second voltage measuring point MP2 to be as close as possible to the arc LB. In a manual welding device with a separate feed unit 6, the first voltage measuring point MP1′ can also be provided, for example, on the feed unit 6, analogously to the configuration in FIG. 1. The second voltage measuring point MP2 could, for example, again lie directly on the workpiece W.

Special measuring lines with ohmic resistance as low as possible, and preferably lower than 0.5Ω, are preferably used as measuring lines ML1, ML2. Since no, or only a negligibly small, current, flows in the measuring lines during the voltage measurement, the voltage drop across the measuring lines ML1, ML2 is very low compared to a voltage drop across the welding lead 9, and can therefore be neglected. The length of the measuring lines ML1, ML2 thus contributes only to an insignificant extent to the voltage drop. Furthermore, it can be advantageous if the first measuring line ML1 and the second measuring line ML2 are twisted at least in sections. As a result, as is known, the inductive coupling can be reduced—i.e., the voltage induction into the measuring lines ML1, ML2 by other current-carrying lines (e.g., welding leads 9, ground cables M) in the vicinity of the measuring lines ML1, ML2. In FIG. 1, this is indicated by the dot-dashed twisting region B, which adjoins the voltage measuring sockets MB1, MB2. In this case, it is likewise advantageous if the measuring lines ML1, ML2 are twisted over as large a region of their length as possible. In the example shown, the twisting region B ends at the point at which the measuring lines ML1, ML2 divide in the direction of the robot arm 3a or in the direction of the workpiece W. If necessary, the ground potential could also be guided further into the vicinity of the robot arm 3a or the welding torch 4, so that a twisting of the measuring lines ML1. ML2 is enabled over a greater region of their length.

Two variants for the detection of the error state in the second welding voltage signal U2 are described below with reference to FIG. 2 and FIG. 3. The two variants can alternatively be used, but can of course also be used redundantly. FIG. 2 shows an equivalent circuit diagram of the welding current circuit from FIG. 1. After the ignition of an arc LB between the electrode E and the workpiece W, the welding current circuit is completed, so that a welding current I which is provided by the welding current source 8 flows. The welding parameters (welding current I, welding voltage U, etc.) are set, and in particular controlled, by the control unit 7 during the execution of the welding process. The first welding voltage signal U1 is measured by means of the first voltage-measuring device 12 of the welding device 1 between the (not shown in FIG. 2) connection sockets AB1, AB2 (see FIG. 1). The second welding voltage signal U2 is detected by means of the second voltage-measuring device 13 of the welding device 1 between the first voltage measuring point MP1 in the welding lead 9 and the second voltage measuring point MP2 in the ground cable M (or directly on the workpiece W). The second voltage-measuring device 13 is here arranged, for example, within the welding tool 2. In addition, a suitable current measuring device 15 can of course also be provided for measuring the welding current I in the welding device 1—for example, in the welding tool 2, as indicated in FIG. 2 and FIG. 3.

In order to detect the error state in the second welding voltage signal U2, a measurement voltage source 14 can in the welding device 1 be provided in addition to the welding current source 8. The measurement voltage source 14 is here electrically connected to the two voltage measuring sockets MB1. MB2 in order to be able to apply a measurement voltage UM to the measuring lines ML1, ML2. If only one voltage measuring socket MB1 or MB2 is provided, the measurement voltage source 14 is connected to the corresponding voltage measuring socket MB1, MB2 and one of the connection sockets AB1, AB2. The control unit 7 in this case can detect the error state in the second welding voltage signal U2 of the second voltage-measuring device 13 on the basis of electrical measurement voltage UM generated by the measurement voltage source 14. If an error state occurs during the execution of the welding process, e.g., because a measuring line ML1. ML2 detaches from the corresponding voltage measuring socket MB1, MB2 or from the corresponding measuring point MP1, MP2, or a measuring line ML1, ML2 breaks, then the second voltage-measuring device 13 measures only the measurement voltage UM which is provided by the measurement voltage source 14. The measurement voltage UM advantageously differs qualitatively and quantitatively from the welding voltage U, and is known. For example, a known characteristic voltage signal having a constant voltage or an alternating voltage of a certain frequency can be specified as the measurement voltage UM. As a result, the control unit 7 can easily recognize when an error state is present, because only the characteristic voltage is still measured in the error state.

In order to enable the error state to be recognized as simply and quickly as possible, it is advantageous if the measurement voltage source 14 has an opposite electrical polarity to that of the welding current source 8, as shown in FIG. 2. As a result, in the event of a fault, the sign in the second welding voltage signal U2 changes, which is detected by the second voltage-measuring device 13. The error state can be detected within 20-50 μs, for example.

Furthermore, it can be advantageous if the measurement voltage source 14 is connected to at least one voltage measuring socket MB1, MB2. Additionally or alternatively, it can be advantageous if the measurement voltage source 14 is connected to at least one voltage measuring socket MB1, MB2 via at least one known ohmic resistor RM. “High ohmic resistance” means, as is known, the highest possible impedance, e.g. >100 kΩ. In the circuit according to FIG. 2, for example, an ohmic resistor RM with 100 kΩ is arranged between the positive terminal of the measurement voltage source 14 and the first voltage measuring socket MB1, and an ohmic resistor RM with 100 kΩ is arranged between the negative terminal of the measurement voltage source 14 and the second voltage measuring socket MB2. Due to the high-impedance terminal, the measurement voltage UM in normal operating mode (without error state) is negligible for the detection of the second welding voltage signal U2 in the welding current circuit, so that no substantial falsification of the second welding voltage signal U2 results. If the ohmic resistance RM of the measurement voltage source 14 is alternatively or additionally known, the voltage drop at the resistors RM can be calculated and taken into account during the detection of the second welding voltage signal U2, so that the second welding voltage signal U2 can, optionally, be corrected.

However, the detection of the error state in the second welding voltage signal U2 of the second voltage-measuring device 13 can in principle also take place without an additional measurement voltage source 14. For this purpose, for example, a welding current circuit model can be stored in the control unit 7, via which the error state can be detected. An exemplary welding current circuit model is shown in FIG. 3. The welding current circuit model preferably contains at least one model of the welding lead 9, wherein the model of the welding lead 9 contains at least one ohmic resistor R1 and at least one inductor L1. In the example shown in FIG. 3, the model of the welding lead 9 has, for example, two ohmic resistors R1, R2 and two inductors L1, L2. The first resistor R1 and the first inductor L1 model the part of the welding lead 9 between the first connection socket AB1 and the first measuring point MP1 (see also in this regard FIG. 1+FIG. 2). The second resistor R2 and the second inductor L2 model the part of the welding lead 9 between the first measuring point MP1 and the electrode E. The arc LB can also be modeled in the form of an ohmic resistor RLB.

Of course, further components such as the measuring lines ML1, ML2, the connection sockets AB1, AB2, the voltage measuring sockets MB1, MB2, and the measuring points MP1, MP2 could also be taken into account in the welding current circuit model in order to model the actual structure of the welding device 1 as realistically as possible. For this purpose, corresponding ohmic resistors R, inductors L, and possibly further electrical replacement elements can again be provided. In order to adapt the welding current circuit model as well as possible to an actually-constructed welding current circuit of the welding device 1, it can also be advantageous if model parameters of the welding current circuit model can be adjusted or automatically identified. For example, variable ohmic resistances R, inductors L, etc., can be provided, and can be changed by a user depending upon the specifically implemented design—for example, via the user interface on the welding tool 2 or via a higher-level control unit, e.g., the robot control unit 11.

An automatic identification of the model parameters of the welding circuit model can be effected, for example, by a comparison before the welding process is carried out. However, during this comparison, welding is not actually carried out. Rather, the welding torch 4 is simply moved towards the workpiece W, so that the contact tube 4a touches the welding point of the workpiece W. In this case, a matching algorithm is carried out by means of the control unit 7 in order to determine the model parameters (e.g., inductor and ohmic resistance) of the welding current circuit model. In welding processes in which the amplitude of the welding current I changes over time (e.g., during pulse welding), the inductance can optionally also be determined as model parameter during the execution of the welding process. In the phases in which the current change takes place, a current value for the inductor is determined, and the model parameter can optionally be updated directly.

In order to detect the error state in the second welding voltage signal U2 of the second voltage-measuring device 13, the control unit 7 compares the second welding voltage signal U2—preferably continuously or in predefined time steps—measured by the second voltage-measuring device 13, with the calculated second welding voltage signal U2 from the welding current circuit model. If a prespecified or adjustable deviation is detected, e.g., because a measuring line ML1, ML2 has detached, broken, or been damaged, the control unit 7 automatically switches from the normal operating mode into the emergency operating mode, and the welding process continues during the switchover. In the emergency operating mode, the control unit 7 uses, instead of the second welding voltage signal U2, the first welding voltage signal U1 to determine the control parameters. The welding process can thus be continued and completed without interruption. After completion (when the arc LB is extinguished), an error diagnosis can be carried out on the welding device 1, and the fault can be rectified.

If the fault cause is, for example, a detached measuring line ML1, ML2, the corresponding measuring line ML1, ML2 can again be connected to the corresponding voltage measuring socket MB1, MB2 or the measuring point MP1, MP2, and a new welding process can be started again in normal operating mode. For this purpose, it can be provided, for example, that the control unit 7 have stored the normal operating mode after each start of a welding process, i.e., after the ignition of the arc LB, as an initial setting. In order to avoid greater errors in the welding seam, which can result during the time period of the switchover due to the incorrect or missing second welding voltage signal U2, the switchover from the normal operating mode to the emergency operating mode takes place within the shortest possible time, and preferably within 25-100 μs. As already mentioned, in the emergency operating mode in which the first welding voltage signal U1 is used to regulate the welding voltage, a known RL comparison can also take place in which the voltage drop in the welding lead 9 is determined by a model and is taken into account when detecting the welding voltage.

As a result, the voltage drop in the welding lead 9 can also be taken into account in the emergency operating mode. Of course, welding could also continue in emergency operating mode for a longer period of time, but this may lead to reduced welding quality under certain circumstances. As described at the outset, this can be the case, for example, if several parallel welding processes are carried out, wherein the welding leads 9 and ground cables M are laid in spatial proximity. By means of a temporally variable welding current in a line, an undesired voltage induction can occur in an adjacent line, which can lead to a falsification of the first welding voltage signal U1 which is measured at the connection sockets AB1, AB2. Since, in the emergency operating mode, the first welding voltage signal U1 is used to regulate the welding process, this can result in undesirable deviations from the predefined welding process and possibly to an insufficient welding quality. In order to avoid these problems, it is therefore advantageous if the switch back to the normal operating mode occurs as quickly as possible, in which normal operating mode the second welding voltage signal U1 is used to regulate the welding process—which is substantially uninfluenced by the inductive coupling of the lines.

Finally, it should be noted again that the invention is of course not limited to the welding device 1 shown with welding robots 3 and MSG welding methods. Of course, the invention could also be applied in a welding device 1 without welding robots 3, which is provided for manual welding. Likewise, the invention is not limited to the MSG welding method, but could of course also be used in other welding methods—for example, in TIG welding with a non-consumable electrode.

1. A welding device for carrying out a welding process with an electrode on a workpiece, wherein a welding current source is provided in the welding device, and has a first connection socket for electrically connecting a welding torch by a welding lead and a second connection socket for electrically connecting a workpiece by a ground cable, wherein a first voltage-measuring device for detecting a first electrical welding voltage signal between the connection sockets is provided in the welding device, wherein a voltage measuring socket for connecting a measuring line or two voltage measuring sockets for connecting one measuring line each are provided in the welding device, wherein a second voltage-measuring device for detecting a second electrical welding voltage signal between the one voltage measuring socket and one of the connection sockets or between the two voltage measuring sockets is provided in the welding device, wherein a control unit is provided in the welding device, which is designed to use at least one of the welding voltage signals to determine control parameters for controlling or regulating the welding process, and to control the welding current source with the determined control parameters, wherein the control unit is designed to ignore the first welding voltage signal of the first voltage-measuring device, and to use the second welding voltage signal of the second voltage-measuring device to determine the control parameters in a normal operating mode, wherein the control unit is further designed to detect an error state in the second welding voltage signal on the basis of the second welding voltage signal, and to switch to an emergency operating mode without interrupting the welding process upon detecting the error state, and wherein the control unit is designed to ignore the second welding voltage signal of the second voltage-measuring device in an emergency operating mode, and to use the first welding voltage signal of the first voltage-measuring device to determine the control parameters.

2. The welding device according to claim 1, wherein a welding torch is electrically connected to the first connection socket by a welding lead, and a ground cable connected or connectable to the workpiece is electrically connected to the second connection socket, and wherein a first measuring line is connected to the one voltage measuring socket, and is electrically connected to a first voltage measuring point in the welding lead located between the first connection socket and the electrode of the welding torch, wherein the second voltage-measuring device is designed to detect the second electrical welding voltage signal between the one voltage measuring socket and the second connection socket, or wherein a second measuring line is connected to the one voltage measuring socket, and is electrically connected to a second voltage measuring point in the ground cable, or can be electrically connected to the workpiece, wherein the second voltage-measuring device is designed to detect the second electrical welding voltage signal between the one voltage measuring socket and the first connection socket.

3. The welding device according to claim 1, wherein a welding torch is connected to the first connection socket by a welding lead, and a ground cable connected or connectable to the workpiece is connected to the second connection socket, wherein a first measuring line is connected to one of the two voltage measuring sockets, and is electrically connected to a first voltage measuring point in the welding lead located between the first connection socket and the electrode of the welding torch, and a second measuring line is connected to the other voltage measuring socket, and is electrically connected to a second voltage measuring point in the ground cable, or can be electrically connected to the workpiece, wherein the first measuring line and the second measuring line are preferably twisted at least in sections.

4. The welding device according to claim 1, wherein a feed unit for feeding a welding wire to the welding torch is provided in the welding device, wherein the second voltage-measuring device and the one voltage measuring socket or the two voltage measuring sockets is/are provided on the feed unit, and that the second voltage-measuring device is connected to the control unit via a communications connection for transmitting the second electrical welding voltage signal.

5. The welding device according to claim 1, wherein an additional measurement voltage source is provided in the welding device, which is connected to the two voltage measuring sockets, or which is connected to the one voltage measuring socket and one of the connection sockets, wherein the control unit is designed to detect the error state in the second welding voltage signal on the basis of an electrical measurement voltage generated by the measurement voltage source.

6. The welding device according to claim 5, wherein the measurement voltage source has an opposite electrical polarity to that of the welding current source.

7. The welding device according to claim 5, wherein the measurement voltage source is connected to at least one voltage measuring socket with high impedance, and/or wherein the measurement voltage source is connected to at least one voltage measuring socket via at least one known ohmic resistor.

8. The welding device according to claim 1, wherein a welding current circuit model is stored in the control unit, and wherein the control unit is designed to detect the error state in the second welding voltage signal on the basis of the welding current circuit model, wherein the welding current circuit model preferably contains at least one model of the welding lead, wherein the model of the welding lead preferably contains at least one ohmic resistor and at least one inductor.

9. The welding device according to claim 8, wherein model parameters of the welding current circuit model can be adapted to the welding current circuit of an actually-constructed welding device.

10. The welding device according to claim 2, wherein a welding robot is provided in the welding device, wherein the welding torch is arranged on the welding robot and can be moved by the welding robot, and wherein the first voltage measuring point is provided on the welding robot, preferably in the region of the welding torch.

11. A method for carrying out a welding process with an electrode on a workpiece, wherein the electrode is connected to a welding current source by a welding lead, and the workpiece is connected to the welding current source by a ground cable, wherein a welding current circuit is closed between the electrode and the workpiece after the ignition of an are, wherein a first electrical welding voltage signal and a second electrical welding voltage signal are detected in the welding current circuit, wherein the second electrical welding voltage signal is detected closer to the arc than the first electrical welding voltage signal, wherein the detected welding voltage signals are transmitted to a control unit, and wherein the control unit uses at least one of the welding voltage signals to determine control parameters for controlling or regulating the welding process, and wherein the control unit controls the welding current source with the determined control parameters, the control unit ignores the first welding voltage signal in a normal operating mode, and uses the second welding voltage signal to determine the control parameters, wherein the control unit detects an error state in the second welding voltage signal on the basis of the second welding voltage signal and switches to an emergency operating mode without interrupting the welding process upon detecting the error state, preferably within 100 μs, and wherein the control unit ignores the second welding voltage signal in the emergency operating mode, and uses the first welding voltage signal to determine the control parameter.

12. The method according to claim 11, wherein the error state in the second welding voltage signal is detected on the basis of a welding current circuit model of the welding current circuit stored in the control unit.

13. The method according to claim 12, wherein the welding current circuit model contains at least one model of the welding lead wherein the model of the welding lead preferably contains at least one ohmic resistor and at least one inductor.

14. The method according to claim 12, wherein model parameters of the welding current circuit model are adapted to a welding current circuit of an actually-constructed welding device.

15. The method according to claim 11, wherein a measurement voltage is applied to the welding current circuit by an additional measurement voltage source, and wherein the control unit detects the error state in the second welding voltage signal on the basis of the measurement voltage, wherein the measurement voltage source is preferably connected to the welding current circuit with high impedance and/or via a known ohmic resistor, and wherein an electrical polarity opposite to the welding current source is preferably provided at the measurement voltage source.
